(19) United States
(12) Patent Application Publication
(10) Pub. No.: US 2023/0214706 A1
(43) Pub. Date: Jul. 6, 2023

(54) AUTOMATED GENERATION OF AGENT CONFIGURATIONS FOR REINFORCEMENT LEARNING

(71) Applicant: Microsoft Technology Licensing, LLC, Redmond, WA (US)

(72) Inventor: Marco ROSSI, Harrisonburg, VA (US)

(73) Assignee: Microsoft Technology Licensing, LLC, Redmond, WA (US)

(21) Appl. No.: 17/566,888

(22) Filed: Dec. 31, 2021

(51) Int. Cl. G06N 20/00

(52) U.S. Cl. CPC G06N 20/00

(57) ABSTRACT

This document relates to reinforcement learning. One example includes a system having a processor and a storage medium. The storage medium can store instructions which, when executed by the processor, cause the system to identify a selected agent configuration having a corresponding selected reward function based at least on predicted performance of a plurality of alternative agent configurations for an evaluation metric. The instructions can also cause the processor to operate the agent in the selected agent configuration. The selected agent configuration can cause the agent to adapt internal parameters of the agent according to the selected reward function.

### BACKGROUND

Reinforcement learning enables automated agents to learn policies according to a defined reward function. One way to create an agent is by having a human user manually generate the reward function. However, manual generation of reward functions or other aspects of an automated agent can have various drawbacks.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for configuring an agent to perform reinforcement learning. One example includes a method or technique that can be performed on a computing device. The method or technique can include obtaining an event log of events representing reactions of an environment to actions taken by an agent, the agent having selected the actions based on associated context according to a previous agent configuration. The method or technique can also include, based at least on the events in the event log, predicting performance of a plurality of alternative agent configurations for an evaluation metric. The plurality of alternative agent configurations can include at least two different reward functions. The method or technique can also include, based at least on the predicted performance of the plurality of alternative agent configurations for the evaluation metric, identifying a selected agent configuration having a corresponding selected reward function. The method or technique can also include configuring the agent according to the selected agent configuration. The selected agent configuration can cause the agent to adapt internal parameters of the agent according to the selected reward function.

Another example includes a system having a hardware processing unit and a storage resource storing computer-readable instructions. When executed by the hardware processing unit, the computer-readable instructions can cause the hardware processing unit to, based at least on predicted performance of a plurality of alternative agent configurations for an evaluation metric, identify a selected agent configuration having a corresponding selected reward function. The computer-readable instructions can also cause the hardware processing unit to operate the agent in the selected agent configuration. The selected agent configuration can cause the agent to adapt internal parameters of the agent according to the selected reward function.

Another example includes a hardware computer-readable storage medium storing computer-readable instructions. When executed by the hardware processing unit, the computer-readable instructions can cause the hardware processing unit to perform acts. The acts can include, based at least on predicted performance of a plurality of alternative agent configurations for an evaluation metric, identifying a selected agent configuration having a corresponding selected reward function. The acts can also include configuring the agent according to the selected agent configuration having the selected reward function. The acts can also include receiving, from an application, an application programming interface (API) call to the agent requesting that the agent select an action from a plurality of available actions based on a current context of an environment. The acts can also include selecting a particular action from the plurality of available actions based at least on reward values determined according to the selected reward function. The acts can also include responding to the API call by identifying the particular action to the application.

The above listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example learning framework, consistent with some implementations of the present concepts.

FIG. 2 illustrates an example agent that can be configured to perform reinforcement learning, consistent with some implementations of the present concepts.

FIG. 3 illustrates an example workflow for predicting performance of alternative agent configurations for an evaluation metric, consistent with some implementations of the disclosed techniques.

FIG. 4 illustrates an example data structure for storing performance predictions, consistent with some implementations of the disclosed techniques.

FIGS. 5-7 illustrate example graphical user interfaces that convey the performance of alternative agent configurations for evaluation metrics, consistent with some implementations of the present concepts.

FIG. 8 illustrates an example system, consistent with some implementations of the disclosed techniques.

FIG. 9 is a flowchart of an example method for configuring an agent to perform reinforcement learning, consistent with some implementations of the present concepts.

FIGS. 10A and 10B illustrate example user experiences and user interfaces for content distribution scenarios, consistent with some implementations of the present concepts.

FIGS. 11A and 11B illustrate example user experiences and user interfaces for voice or video call scenarios, consistent with some implementations of the present concepts.

### DETAILED DESCRIPTION

### Overview

Reinforcement learning generally aims to train an agent to learn a policy that maximizes or increases the sum of rewards of a specified reward function. For instance, an agent can balance exploring new actions and exploiting knowledge gained by rewards received for previous actions. Provided the reward function is defined in a manner that results in the preferred outcomes for the user that is employing the agent, reinforcement learning can provide a very flexible approach that allows agents to adapt well to changing scenarios.

In traditional reinforcement learning, the reward function serves two roles—it acts as a hyperparameter of the agent, and also represents the desired outcome of the user. However, in some cases, human users may have difficulty specifying reward functions that accurately correlate to desired outcomes. Users can change their reward functions if they would like, but then the agent needs to learn a new policy with the updated reward function and apply the new policy before the user can determine whether the new reward function has improved the performance of the agent. Even if the new reward function improves the performance of the agent, the user may not fully understand how changing the reward function affects learning by the agent. Thus, there may be alternative reward functions that the user has not considered that could improve the performance of the agent even more.

In addition, agents have other characteristics that are traditionally specified manually by a user. For instance, agents evaluate input features in order to select an action, and the feature definition for the features that an agent receives can influence its performance at a given task. Human users may not necessarily understand how different feature representations can influence the learning process of an agent. As another example, agents have hyperparameters such as learning rates that can influence the performance of an agent, and it can also be difficult for human users to appreciate the significance of how different hyperparameters can influence how an agent learns over time.

As noted above, it can be very difficult for a user, particularly someone that is not an expert in reinforcement learning, to select a good reward function, features, and hyperparameters for an agent. The disclosed implementations can help automate the selection of an agent configuration that can specify a reward function, feature definition, and/or hyperparameters for a reinforcement learning model of an agent. For example, the disclosed implementations can evaluate different alternative agent configurations using a log of events and select an agent configuration based on the evaluation. More specifically, the disclosed implementations can predict how different reward functions, feature definitions, and/or hyperparameters will influence performance of the agent with respect to one or more evaluation metrics. Then, an agent configuration can be selected and deployed based on the predicted performance. Thus, the agent can be configured to a new configuration that performs well with respect to evaluation metrics of interest to a user, without necessarily requiring the user to define the reward function, feature definition, or hyperparameters of the agent.

### Reinforcement Learning Overview

Reinforcement learning generally involves an agent taking various actions in an environment according to a policy, and adapting the policy based on the reaction of the environment to those actions. Reinforcement learning does not necessarily rely on labeled training data as with supervised learning. Rather, in reinforcement learning, the agent evaluates reactions of the environment using a reward function and aims to determine a policy that tends to maximize or increase the cumulative reward for the agent over time.

In some cases, a reward function can be defined by a user according to the reactions of an environment, e.g., 1 point for a desired outcome, 0 points for a neutral outcome, and −1 point for a negative outcome. The agent proceeds in a series of steps, and in each step, the agent has one or more possible actions that the agent can take. For each action taken by the agent, the agent observes the reaction of the environment, calculates a corresponding reward according to the reward function, and can update its own policy based on the calculated reward.

Reinforcement learning can strike a balance between “exploration” and “exploitation.” Generally, exploitation involves taking actions that are expected to maximize the immediate reward given the current policy, and exploration involves taking actions that do not necessarily maximize the expected immediate reward but that search unexplored or under-explored actions. In some cases, the agent may select an action in the exploration phase that results in a greater cumulative reward than the best action according to its current policy, and the agent can update its policy to reflect the new information.

In some reinforcement learning scenarios, an agent can utilize context describing the environment that the agent is interacting with in order to choose which action to take. For instance, a contextual bandit receives context features describing the current state of the environment and uses these features to select the next action to take. A contextual bandit agent can keep a history of rewards earned for different actions taken in different contexts and continue to modify the policy as new information is discovered.

One type of contextual bandit is a linear model, such as Vowpal Wabbit. Such a model may output, at each step, a probability density function over the available actions, and select an action randomly from the probability density function. The model may learn feature weights that are applied to one or more input features (e.g., describing context) to determine the probability density function. When the reward obtained in a given step does not match the expected reward, the agent can update the weights used to determine the probability density function.

### Definitions

For the purposes of this document, an agent is an automated entity that can determine a probability distribution over one or more actions that can be taken within an environment, and/or select a specific action to take. An agent can determine the probability distribution and/or select the actions according to a policy. For instance, the policy can map environmental context to probabilities for actions that can be taken by the agent. The agent can refine the policy using a reinforcement learning model that updates the policy based on reactions of the environment to actions selected by the agent.

A reinforcement learning model is an algorithm that can be trained to learn a policy using a reward function. The reinforcement learning model can update its own internal parameters by observing reactions of the environment and evaluating the reactions using the reward function. The term “internal parameters” is used herein to refer to learnable values such as weights that can be learned by training a machine learning model, such as a linear model or neural network.

A reinforcement learning model can also have hyperparameters that control how the agent acts and/or learns. For instance, a reinforcement learning model can have a learning rate, a loss function, an exploration strategy, etc. A reinforcement learning model can also have a feature definition, e.g., a mapping of information about the environment to specific features used by the model to represent that information. A feature definition can include what types of information the model receives, as well as how that information is represented. For instance, two different feature definitions might both indicate that a model receives a context feature describing an age of a user, but one feature definition might identify a specific age in years (e.g., 24, 36, 68, etc.) and another feature definition might only identify respective age ranges (e.g., 21-30, 31-40, and 61-70).

An agent configuration is a specification of at least one of a reward function, a feature definition, or a hyperparameter. A policy is a function used to determine what actions that an agent takes in a given context. A policy can be learned using reinforcement learning according to an agent configuration. However, policies for an agent can also be defined heuristically or using a static probability distribution, e.g., an agent could use a uniform random sampling strategy from a set of available actions without necessarily updating the strategy in response to environmental reactions.

### Example Learning Framework

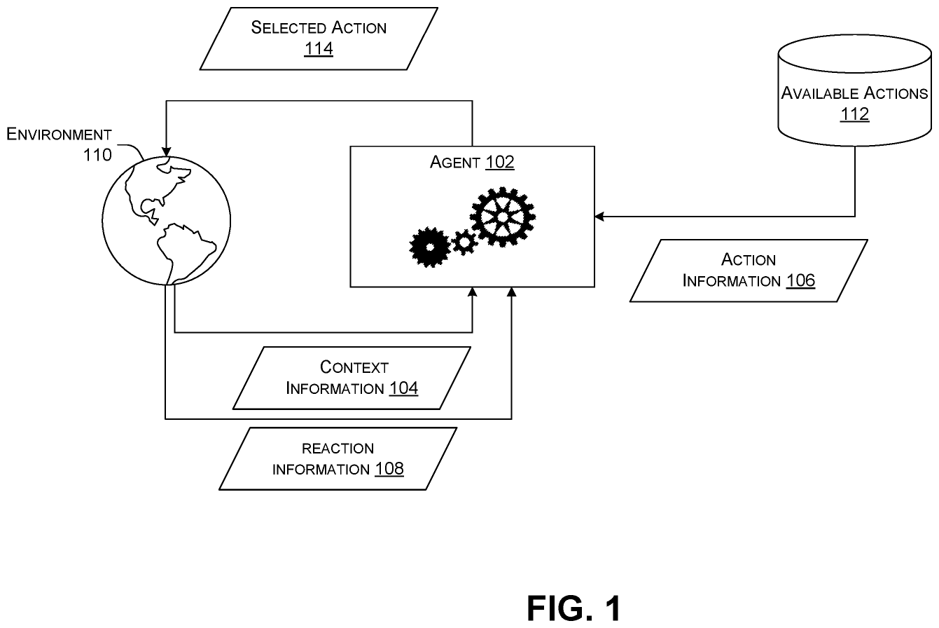

FIG. 1 shows an example where an agent 102 receives context information 104, action information 106, and reaction information 108. The context information represents a state of an environment 110. The action information represents one or more available actions 112. The agent can choose a selected action 114 based on the context information. The reaction information can represent how the state of the environment changes in response to the action selected by the agent. The reaction information 108 can be used in a reward function to determine a reward for the agent 102 based on how the environment has changed in response to the selected action.

In some cases, the actions available to an agent can be independent of the context—e.g., all actions can be available to the agent in all contexts. In other cases, the actions available to an agent can be constrained by context, so that actions available to the agent in one context are not available in another context. Thus, in some implementations, context information 104 can specify what the available actions are for an agent given the current context in which the agent is operating.

### Example Agent Components

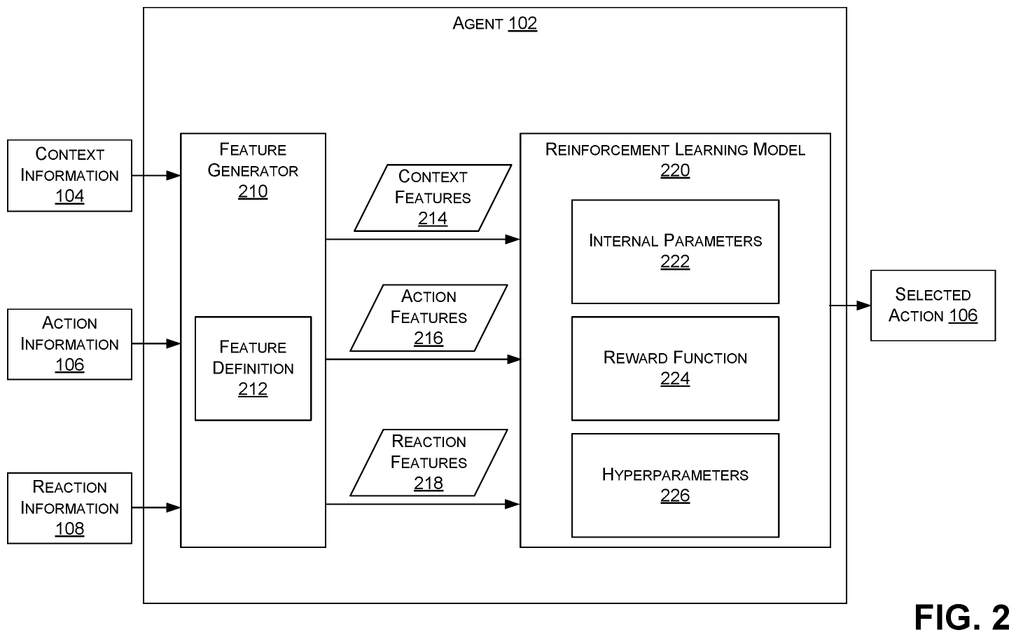

FIG. 2 illustrates components of agent 102, a feature generator 210 and a reinforcement learning model 220. The feature generator 210 uses feature definition 212 to generate context features 214 from context information 104, action features 216 from action information 106, and reaction features 218 from reaction information 108. The context features represent a context of the environment in which the agent is operating, the action features represent potential actions the agent can take, and the reaction features represent how the environment reacts to an action selected by the agent. Thus, the reaction information may be obtained later in time than the context information and action information.

The reinforcement learning model 220 uses internal parameters 222 to determine selected action 106 from the context features 214 and the action features 216. The reward function 224 calculates a reward based on the reaction features. The hyperparameters 226 can be used to adjust the internal parameters of the reinforcement learning model based on the value of the reward function.

### Example Performance Prediction Workflow

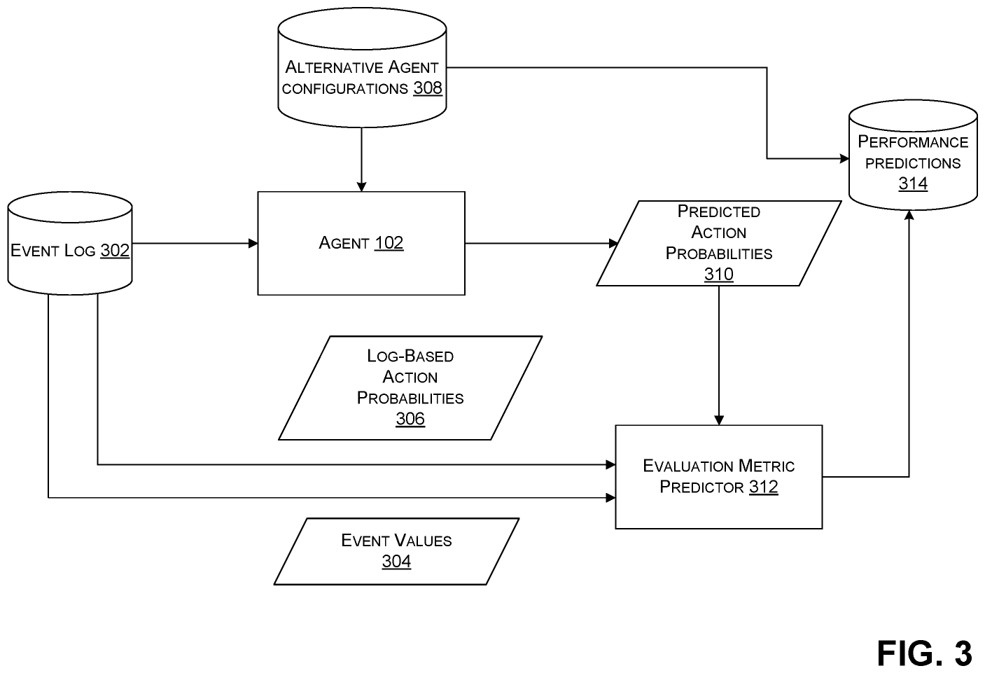

FIG. 3 shows an example where an event log 302 is processed to predict performance of different agent configurations, as described more below. The event log can be obtained by deploying agent 102 to process events according to a previous agent configuration, sometimes referred to herein as the “log agent configuration” to mean the configuration that the agent was in when the event log was generated. Each event in the event log can identify a context associated with the event, an action taken by the agent, and a reaction of the environment to the action. Event values 304 can be determined for each event, where the event values reflect the value of that event with respect to one or more evaluation metrics. In some cases, the event values are determined using a function that maps reactions and, optionally, contexts and actions, to the event values, as described more below.

Log-based action probabilities 306 can be determined for each event in the event log 302, where the log-based action probabilities represent the likelihood that the agent calculated for each event in the log for each action that was taken. Thus, assume that a particular event in the event log indicates that, for a given context associated with that event, the agent determined a probability density function of {Action A==0.7, Action B==0.3}. If the agent took action A for that particular event, then the log-based action probability for that event is 0.7, and if the agent took action B for that particular event, then the log-based action probability for that event is 0.3.

Agent 102 can be reconfigured according to various alternative agent configurations 308. The events in the event log 302 can be replayed using each of the alternative event configurations, so that each alternative event configuration can be used to process the events in the event log offline. Each alternative agent configuration can potentially include a different feature definition, reward function, and/or set of model hyperparameters. For each event in the event log, predicted action probabilities 310 can be predicted. Here, the predicted action probabilities represent the probability that the agent would have taken the action that was taken in the event log had the corresponding alternative agent configuration been used instead of the log agent configuration. Thus, for instance, assume that alternative agent configuration 1 calculated a probability density function of {Action A==0.8, Action B==0.2} for a particular event in the event log. If the event log indicates that the agent took Action A for that event (e.g., when configured by the log agent configuration), then the predicted action probability for that event is 0.8 for alternative agent configuration 1. If the event log indicates that the agent acted B for that event, then the predicted action probability for that event is 0.2 for alternative agent configuration 1.

Evaluation metric predictor 312 can predict aggregate values of one or more evaluation metrics for each alternative agent configuration to populate performance predictions 314. Here, each performance prediction conveys how a particular alternative agent configuration is predicted to perform for a particular evaluation metric. By comparing how different agent configurations are predicted to perform for different evaluation metrics, a selected agent configuration can be identified. Thus, a reward function, feature definition, and/or hyperparameter of the selected agent configuration can be selected without having to manually generate or evaluate alternative reward functions, feature definitions, or hyperparameters. Rather, as discussed more below, intuitive evaluation metrics can be employed that show how different agent configurations influence real-world performance of a reinforcement learning agent.

### Example Performance Prediction Data Structure

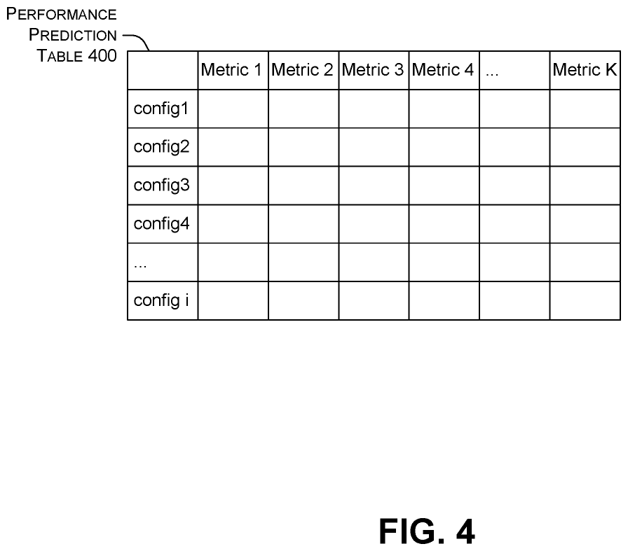

FIG. 4 illustrates a performance prediction table 400, which is one example of a data structure that can be used to store performance predictions 314. Each row of performance prediction table 400 represents a different alternative agent configuration, and each column of the table represents a different evaluation metric. As noted previously, the evaluation metrics can be based on a function that maps environmental reactions, and optionally selected actions and/or context, to a value for a given evaluation metric.

Examples of evaluation metrics and corresponding functions for specific applications are detailed below, but at present, consider the following brief example. Assume a function defines the following values for Metric 1:
for events having reaction 1 when action 1 is selected by the agent in a first context, the value of Metric 1 is 1.
for events having reaction 1 when action 1 is selected by the agent in a second context, the value of Metric 1 is 2.
for events having reaction 1 when action 2 is selected by the agent in the first context, the value of Metric 1 is 10.
for events having reaction 1 when action 2 is selected by the agent in a second context, the value of Metric 1 is 8.
for events with reaction 2, the value of Metric 1 is 0 irrespective of the action selected by the agent or the context.

Using this function, each event in the event log can be extracted and the value of Metric 1 can be determined for that event based on the action that the agent actually took, the context in which the agent took that action, and the reaction of the environment. Then, that value of Metric 1 can be adjusted for each alternative agent configuration as follows. Multiply the value of Metric 1 by the probability that a particular alternative agent configuration would have been given to the same action given the same context for that event, divide that number by the probability that the agent gave to that selected action when in the log agent configuration, and add that value to the column for Metric 1 for the row of the particular agent configuration. These calculations can be performed for every event in the log. The resulting values convey the expected value of Metric 1 in the first column of performance prediction table 400 for each alternative agent configuration. These steps can be performed for different evaluation metrics (e.g., calculated using different functions) to populate the remainder of the table.

### Specific Algorithm

The following provides a more detailed definition of variables and formulas that can be used to populate performance prediction table 400. The term “log agent” is used below to refer to the agent when configured according to the log agent configuration. In other words, “log agent” refers to the configuration state of the agent when the events were collected in the event log 302. For each event in the event log, define the following:
x (vector): this is called context of the decision. It contains the environment (context) features, the possible actions for the agent for each event, and action features for the available actions. The context features describe the environment in which the agent selects a particular agent.
a (index): the action actually taken by the log agent (out of the possible options specified in x).
p_log (scalar between 0 and 1): probability with which the log agent took action a, as indicated in the event log.
y (vector): vector of observation features that describes the reaction of the environment to the action a picked by the log agent.
r (vector): This vector defines the multi-dimensional value of that event, e.g., r is one way to represent a function that maps events to values of one or more evaluation metrics. Each entry in the vector represents the value of a particular evaluation metric of having selected action a in context x given observation features
y were measured. This vector can be user-specified at the time that the alternative agent configurations are evaluated using the events in the log.

For each event in the event log 302, the expected value of that event with respect to a particular evaluation metric for a given alternative agent configuration can be calculated as follows:

$${\sum }_{event i} {r}_{i} \frac{{P}_{i} ( Alternative Configuration )}{{P}_{i} ( Log Agent )}$$

As noted above, rᵢ represents the value of the vector r given the action taken by the log agent, the context in which the action was taken, and the reaction of the environment. Thus, for example, if rᵢ for a given event is {1, 4, . . . 27} given a K-dimensional vector, this means that the event has a value of 1 for evaluation metric 1, a value of 4 for evaluation metric 2, and a value of 27 for evaluation metric K.

Each of the values in rᵢ can be adjusted by multiplying the value by the probability that a given alternative agent configuration would have given to the action taken in the log, divided by the probability that the log agent gave to that action. Thus, this value essentially weights the value of the rᵢ vector higher for the alternative agent configuration if the alternative agent configuration was more likely to have taken the action than the log agent given the context of that event, and lower if the alternative agent configuration was less likely to have taken the action than the log agent given the context of that event.

Note that some implementations may also define constraints on which alternative agent configurations should be considered. For instance, one constraint might specify that only alternative agent configurations with at least a value of 1000 for a particular evaluation metric are considered. Any agent configuration with a lower value can be filtered out prior to selecting a new agent configuration from the remaining available configurations.

### Generalizations

As described above, each column can represent the predicted performance of a given evaluation metric computed over the individual events in the event log 302. In some cases, however, evaluation metrics can be computed over episodes of multiple events. For instance, an episode can be specified as a constant number (e.g., every 10 events), a temporal timeframe (e.g., all events occurring on a given day), or any other grouping of interest to a user. Referring to FIG. 3, episode values computed over an entire episode of events can be used in place of individual event values 304 to determine performance predictions 314.

In addition, the previous description can be used to compute the mean expected value of each evaluation metric. However, further implementations can consider other statistical measures, such as median, percentile values (e.g., 10^{th}, 50^{th}, 90^{th}), standard deviation, etc. These statistical measures can be computed over each individual event in the log or over episodes of multiple events. In addition, confidence intervals can be computed for each statistical measure.

The following formulation:

$$Cell ( {agent}_{j} , {metric}_{k} ) := {f}_{k} ( {[ {r}_{i , k} , {p}_{i , j} ]}_{i ∈ {I}_{k}} ) \pm \begin{matrix}Confidence \\ Interval\end{matrix}$$

$$Where : \{ \begin{matrix}{I}_{k} : indices of episodes for metric k \\ {r}_{i , k} : value of episode i for metric k \\ {p}_{i , j} = \frac{{p}_{i}}{{φ}_{j}} \frac{p ( {episode}_{i} \vert {agent}_{j} )}{p ( {episode}_{i} \vert log )} \\ {φ}_{j} = {\sum }_{i} {p}_{i} \frac{p ( {episode}_{i} \vert {agent}_{j} )}{p ( {episode}_{i} \vert log )}\end{matrix}$$

can be employed to calculate a given statistical measure for any event episode definition.

### Example Output GUI

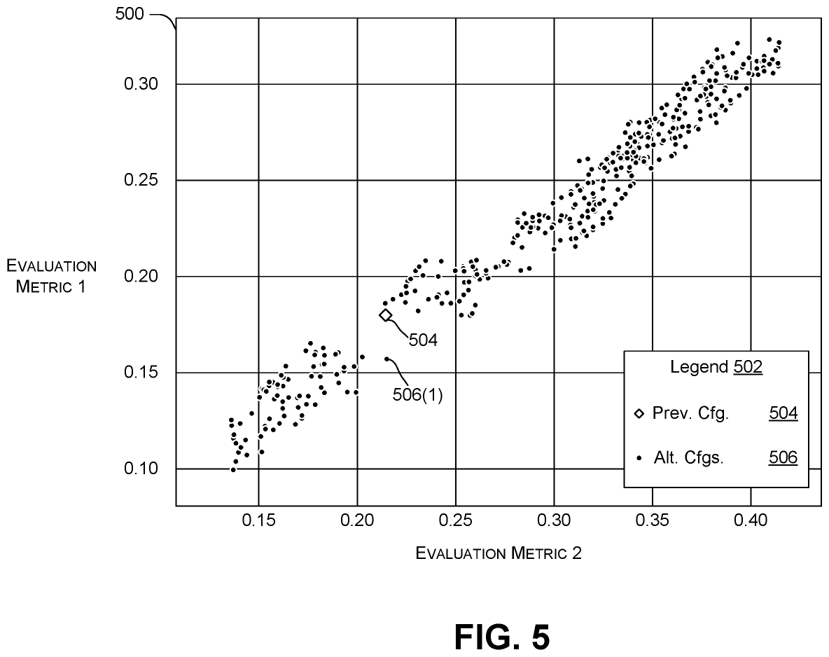

Generally speaking, various graphical user interfaces can be output to convey how different alternative agent configurations have different predicted performance for different evaluation metrics. FIG. 5 illustrates an example output plot 500 with a y axis representing an evaluation metric 1 and an x axis representing an evaluation metric 2. Each entry on plot 500 represents an aggregate value for a particular evaluation metric that is predicted for a corresponding agent configuration. As shown in legend 502, a previous configuration is represented by white diamond 504, which conveys the actual aggregate values of evaluation metrics 1 and 2 for the agent in the log agent configuration. Various alternative agent configurations are represented by round black dots 506, each of which conveys the predicted aggregate values of evaluation metrics 1 and 2 for the agent in a different alternative agent configuration. Thus, plot 500 represents, in graphical form, how different alternative agent configurations with different feature definitions, reward functions, and/or hyperparameters are predicted to perform for two different evaluation metrics.

For instance, consider a first alternative agent configuration represented by dot 506(1). This alternative agent configuration is very near the white diamond 504 representing the previous log agent configuration on the x axis, and well below dot 506(1) on the y axis. Thus, this first alternative agent configuration is likely to result in a relatively lower value for evaluation metric 1 and a similar value for evaluation metric 2 as compared to the log agent configuration. If evaluation metric 1 is a quantity that is useful to minimize (e.g., negative user feedback), this may imply that the first alternative agent configuration represented by dot 506(1) is preferable to the previous agent configuration. On the other hand, if it is useful to maximize evaluation metric 1 (e.g., positive user feedback), this may imply that the previous agent configuration is preferable to the first alternative agent configuration represented by dot 506(1).

Assume for the purposes of the following examples that a user generally would like to maximize the value of evaluation metric 1 while minimizing the value of evaluation metric 2. Observe, however, this involves certain trade-offs, as the value of evaluation metric 2 tends to increase as evaluation metric 1 increases. In other words, those alternative agent configurations with higher values for evaluation metric 1 tend to also result in relatively higher values for evaluation metric 2.

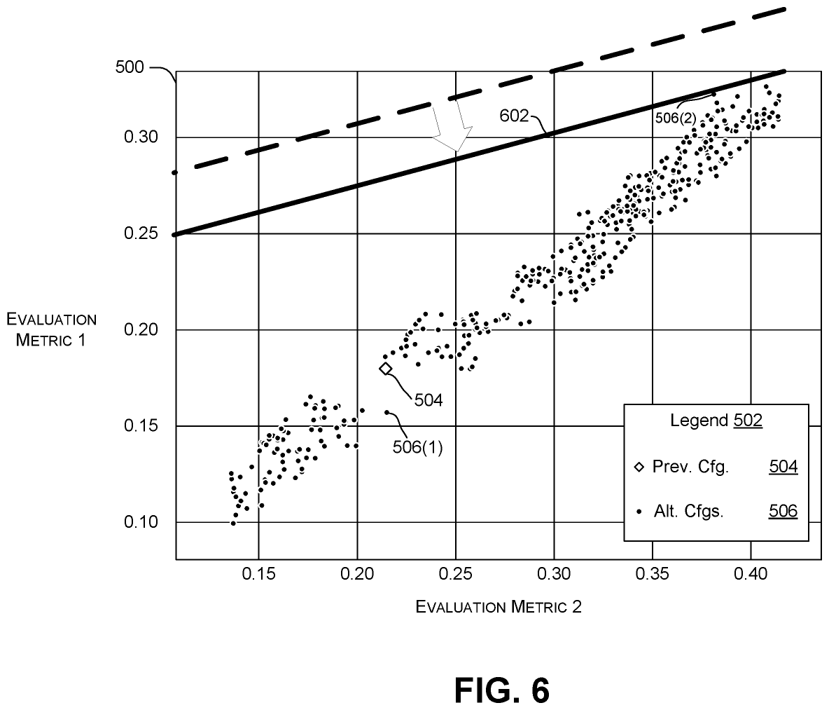

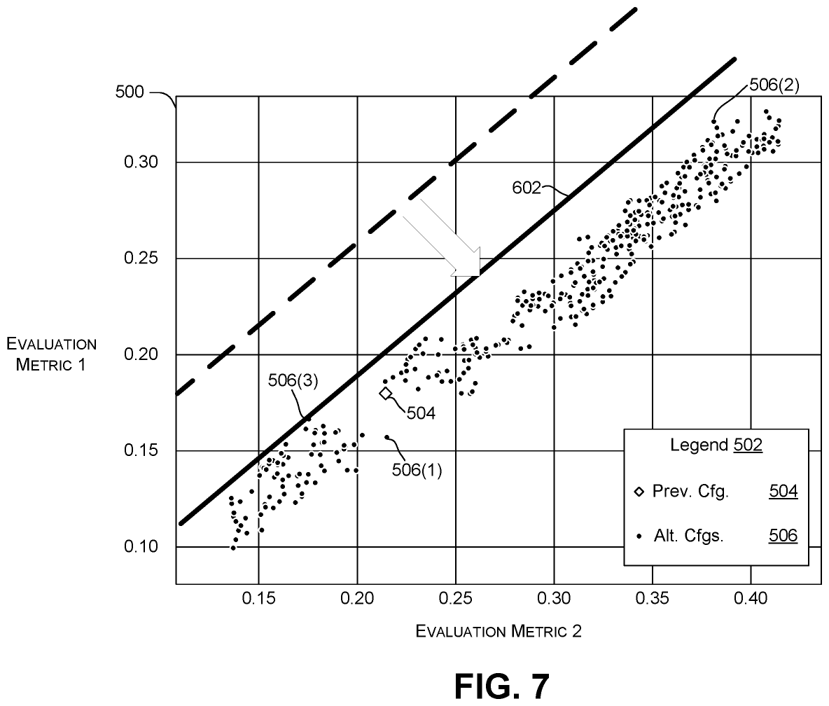

One way to select an agent configuration is to receive user input (e.g., mouse click or touch input) selecting a specific dot 506 from plot 500. Some implementations may offer graphical aids to help a user select specific configurations in an intuitive manner. For instance, FIG. 6 shows an example of a line 602 fitted to plot 500. Line 602 can be shifted down until it contacts dot 506(2) before contacting any other dot. FIG. 7 shows an example of line 602 fitted to plot 500 after having been rotated counterclockwise. When shifted down, line 602 contacts dot 506(3) before contacting any other dot.

Note that line 602 ensures that the user selects a dot and corresponding agent configuration that is optimal or near-optimal in the sense that no other configuration can increase the predicted value of evaluation metric 1 without also increasing the predicted value of evaluation metric 2. Said differently, no other configuration can decrease the predicted value of evaluation metric 2 without also decreasing the predicted value of evaluation metric 1. This is true for dots 506(2) and 506(3) that are contacted by line 602, but not necessarily true for other dots on plot 500.

Note also that the slope of line 602 intuitively allows the user to weight the relative importance of maximizing evaluation metric 1 relative to the importance of minimizing evaluation metric 2. If the user prefers higher values of evaluation metric 1 at the expense of also having higher values of evaluation metric 2, they can manipulate line 602 to have a shallow slope as shown in FIG. 6. On the other hand, if the user is willing to accept lower values of evaluation metric 1 in order to also reduce the value of evaluation metric 2, they can manipulate line 602 to have a steeper slope as shown in FIG. 7.

FIGS. 5-7 illustrate a two-dimensional plot of two evaluation metrics, but these implementations are readily extensible to evaluate additional evaluation metrics. Further implementations can map each alternative agent configuration to a K-dimensional space with one dimension for each of K evaluation metrics. Hyperplanes can be fitted to the space to select, in a fully-automated or user-assisted fashion, a specific agent configuration near or in contact with a given hyperplane.

### Example System

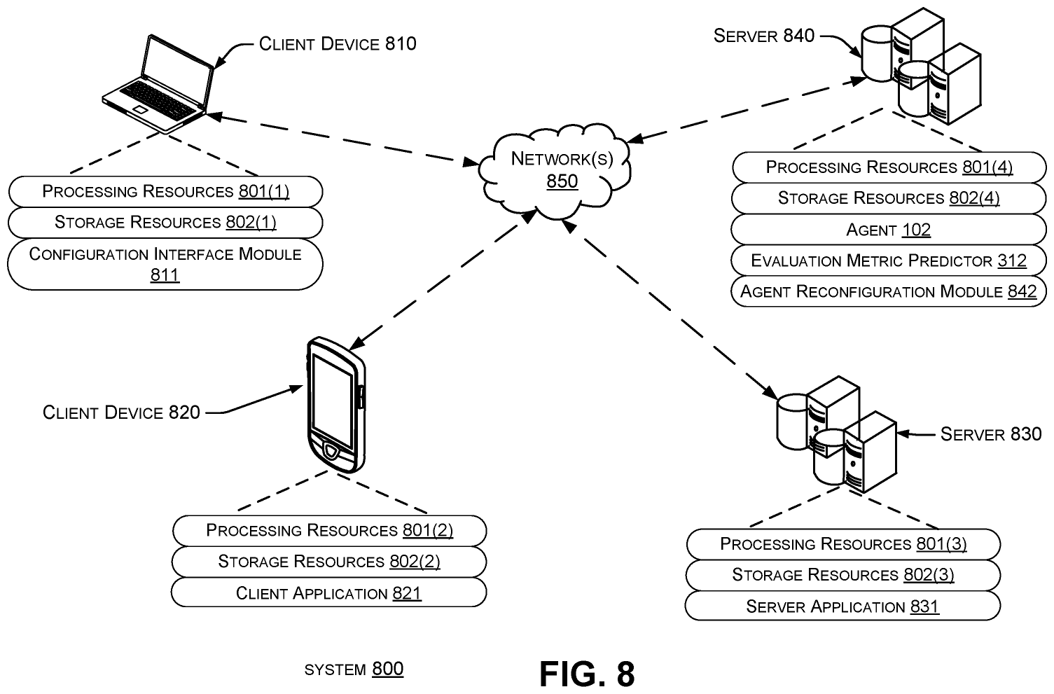

The present implementations can be performed in various scenarios on various devices. FIG. 8 shows an example system 800 in which the present implementations can be employed, as discussed more below.

As shown in FIG. 8, system 800 includes a client device 810, a client device 820, a server 830, and a server 840, connected by one or more network(s) 850. Note that the client devices can be embodied both as mobile devices such as smart phones or tablets, as well as stationary devices such as desktops, server devices, etc. Likewise, the servers can be implemented using various types of computing devices. In some cases, any of the devices shown in FIG. 8, but particularly the servers, can be implemented in data centers, server farms, etc.

Certain components of the devices shown in FIG. 8 may be referred to herein by parenthetical reference numbers. For the purposes of the following description, the parenthetical (1) indicates an occurrence of a given component on client device 810, (2) indicates an occurrence of a given component on client device 820, (3) indicates an occurrence of a given component on server 830, and (4) indicates an occurrence of a given component on server 840. Unless identifying a specific instance of a given component, this document will refer generally to the components without the parenthetical.

Generally, the devices 810, 820, 830, and/or 840 may have respective processing resources 801 and storage resources 802, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Server 840 can include agent 102, evaluation metric predictor 312, and agent reconfiguration module 842. As noted previously, the agent can generate an event log when running in a previous configuration. The evaluation metric predictor can process the event log using one or more alternative agent configurations to determine evaluation metric predictions for each alternative agent configuration. In some cases, the agent configuration module can automatically select one of the alternative agent configurations based on the evaluation metric predictions and configure the agent with the selected agent configuration. One way for the agent configuration module to automatically select an agent configuration is to randomly sample from a Pareto frontier of agent configurations based on predicted performance for one or more evaluation metrics.

In other cases, the agent reconfiguration module can output a graphical user interface, such as plot 500, that conveys information about each alternative agent configuration to client device 810. Client device 810 can include a configuration interface module 811 that displays the GUI to a user and receives input selecting a particular configuration from the GUI. The client device can send a communication to server 840 that identifies the selected agent configuration, and agent reconfiguration module 842 on server 840 can reconfigure agent 102 according to the selected configuration. The agent can operate in the selected agent configuration after being reconfigured.

Server 830 can have a server application 831 that can make API calls to agent 102 on server 840. For instance, a user on client device 820 may be using a client application 821 that interacts with the server application. The server application can send, via the API call, context information and/or action information to the agent 102 on server 840, reflecting context on client device 820 and potential actions that the server application can take. The agent can select a particular action, the server application can perform the selected action, and then the server application can inform the agent of how the client device reacted to the selected action. The agent can calculate its own reward and potentially update its policy based on the reaction.

### Example Method

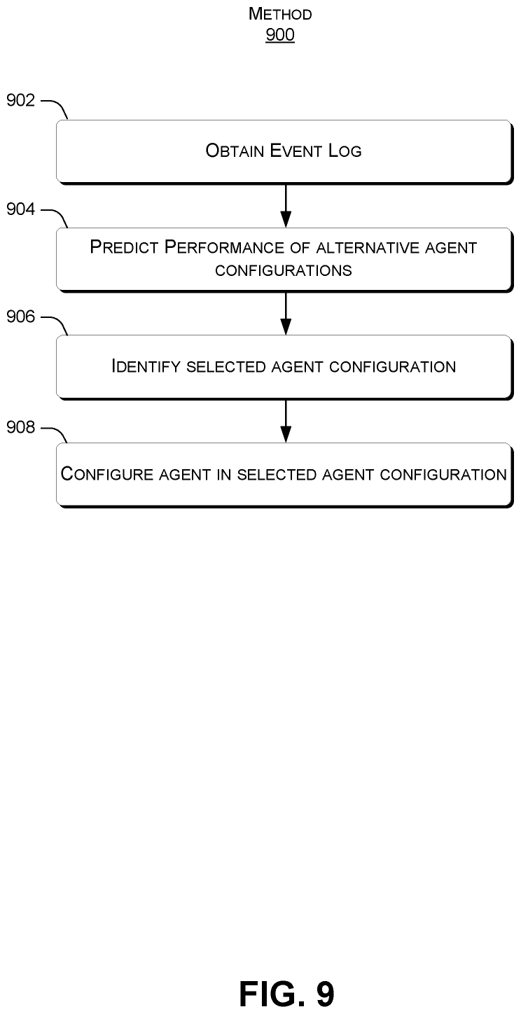

FIG. 9 illustrates an example method 900, consistent with some implementations of the present concepts. Method 900 can be implemented on many different types of devices, e.g., by one or more cloud servers, by a client device such as a laptop, tablet, or smartphone, or by combinations of one or more servers, client devices, etc.

Method 900 begins at block 902, where an event log is obtained. For instance, the event log can be created by an agent when acting within an environment. Events in the event log represent reactions of the environment to various actions taken by the agent based on associated context. The actions represented in the event log may have been selected by the agent according to a previous agent configuration.

Method 900 continues at block 904, where performance of alternative agent configurations is predicted for one or more evaluation metrics. Values of each of the events for the evaluation metric can be determined for each event in the event log, based on a function that maps the reactions of the environment (and potentially the selected actions and/or context) to the values of the evaluation metric. These values can be weighted for each alternative agent configuration based on the probability that the alternative agent configuration gave to the action that was taken according to the event log. The alternative agent configurations can have one or more of alternative reward functions, alternative feature definitions, and alternative agent hyperparameters.

Method 900 continues at block 906, where a selected agent configuration is identified based at least on the predicted performance. For instance, the selected agent configuration can be selected automatically, or responsive to user input identifying the selected agent configuration from a GUI or other user interface. The selected agent configuration can have one or more of a selected reward function, a selected feature definition, and one or more selected agent hyperparameters.

Method 900 continues at block 908, where the agent is configured according to the selected agent configuration. This can include changing one or more of a reward function of the agent, a feature definition of the agent, and/or a hyperparameter of the agent.

Blocks 902, 904, and 906 can be performed by evaluation metric predictor 312. Block 908 can be performed by agent reconfiguration module 842.

### Use Case Concerning Electronic Content Distribution

The disclosed implementations are generally applicable to a wide range of real-world problems that can be solved using reinforcement learning. The following presents a specific use case where a given entity wishes to select an agent configuration for distribution of electronic content.

For the purposes of this example, server application 831 on server 830 can be an application that presents electronic content items to a user of client device 820 by outputting identifiers of the electronic content items to client application 821. Agent 102 can be an agent that receives an API call from the server application, where the API call identifies multiple different potential electronic content items to the agent as well as context reflecting the environment in which the electronic contents will be presented to users. Each potential electronic content item is a potential action for the agent. The agent can select a particular content item for the application to output to the user.

Assume, in a first instance, that the agent was previously configured with a reward function that calculates rewards based solely on how long users play video games selected by the agent, without consideration to the type of video game. Further, assume that a user that oversees a video game platform would like to encourage more engagement by different video game players with each other. However, also assume that this user does not necessarily care which video games that players actually play, only that they engage with the video game platform by comments, likes, or interactions with other video game players.

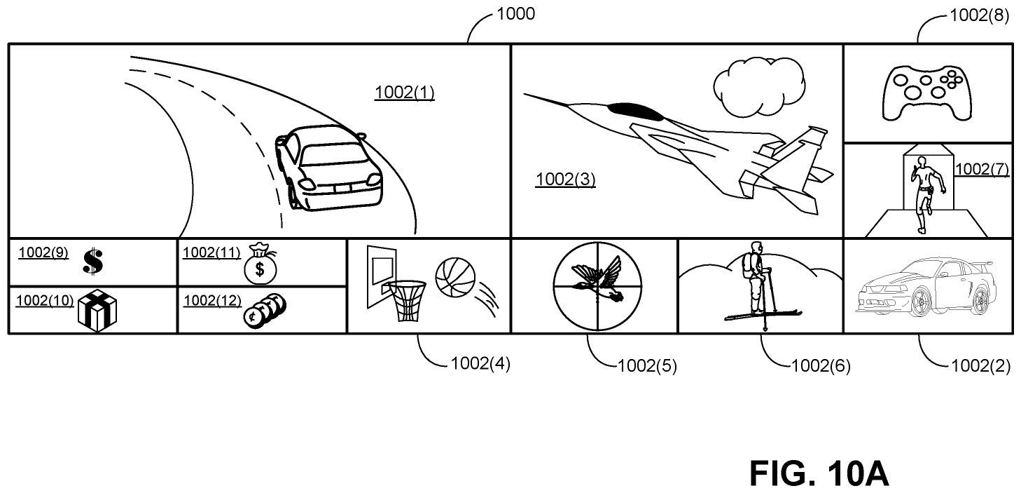

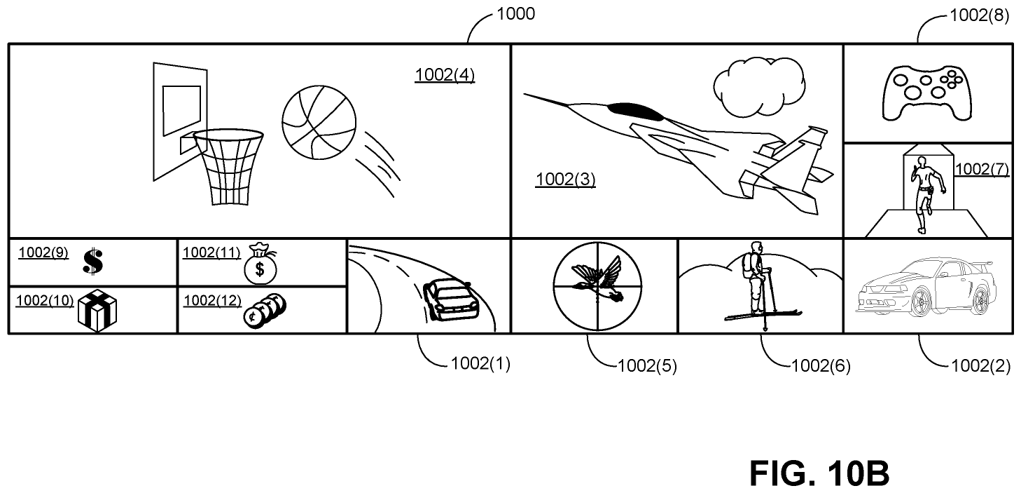

Now, consider a specific video game player that likes to play driving video games and has never played any sports video games. Because this video game player has played lots of hours of driving games, the agent may tend to continue prioritizing driving video games to this video game player. FIG. 10A illustrates an electronic content GUI 1000 with various electronic contents 1002(1)-1002(12) shown to the user. Here, a driving game 1002(1) is selected by the agent as the highest-ranking content item according to the previous agent configuration that calculates its own rewards based on how long users play the games that it recommends. Because the agent recommends the driving video game, the application outputs the driving game in the largest section of the display area. Note that sports video game 1002(4) is also shown but occupies much less screen area.

Now, assume that players of driving video games tend to engage with the video game platform infrequently, e.g., they tend not to communicate with each other or give “likes” to specific games or game scenarios. Further, assume that players of sports games are far more likely to engage with the video game platform. This could be, for instance, because sports games have structured breaks such as timeouts, halftime, etc., that allow time for users to engage more with the platform. Thus, when various agent configurations are evaluated for an evaluation metric related to engagement, it follows that those agent configurations that tend to recommend more sports games will tend to increase engagement relative to those that recommend driving video games. For instance, some agent configurations may have reward functions that have a higher reward for time spent playing sports games than driving games.

FIG. 10B illustrates electronic content GUI 1000 in an alternative configuration using an agent configuration selected according to the disclosed implementations. Now, sports video game 1002(4) occupies the largest area of the screen. This can be a result of the new agent configuration having a different reward function that provides relatively higher rewards for time spent by users playing sports video games and relatively lower rewards for time spent by playing driving video games.

Note that, in this example, the user specifying the new agent configuration did not need to specifically create a reward function that encourages the agent to select sports games over driving games. Rather, the user was concerned with engagement rather than the types of games that users were playing. By replaying the event log through various agent configurations, the disclosed techniques can discover agent configurations with good performance for metrics of interest to the user, without requiring the user to define the reward function for the agent. For instance, the user may have provided a function that defines engagement as one point for clicking a game, two points for liking a game, and three points for commenting on a game. The new agent configuration tends to increase engagement without having a reward function defined according to the engagement metric. Instead, the reward function is defined over features visible to the agent—the selected action e.g., the game and the reaction of the environment, e.g., the time users spend playing games recommended by the agent. Thus, the user is able to select an agent configuration that encourages engagement, without necessarily even needing to recognize that sports games tend to encourage engagement, much less needing to manually define a reward function that encourages the agent to select sports games.

As another example, assume that the agent was previously configured with a reward function that calculates rewards using a very conservative learning rate hyperparameter and considers only how long video game players play the games selected by the agent. Thus, the agent may tend to continue recommending the same video games to the players that they have played in the past, even if they have recently begun to play new video games. In other words, the conservative learning rate hyperparameter causes the agent to react rather slowly to changing preferences of the players.

Now, assume that players who play video games for the first few times tend to engage with the platform more frequently than players who continue to play games they have played previously. Because the reinforcement learning model adapts slowly, the previous agent configuration may inadvertently tend to discourage engagement, even if the previous agent configuration tends to result in a lot of overall video game play. This is because the slow learning rate discourages the agent from reacting when the players start playing new video games, thus driving the user back to video games they have played frequently in past.

Now, assume that a user selects a new agent configuration with a very high predicted engagement value. The new agent configuration may have a much faster learning rate than the old agent configuration. Because the learning rate is faster, the agent may react quickly when the players start playing new games, e.g., recommending the new games over older games previously played by the user even after the users have only played the new games one or two times. However, the user selecting the new agent configuration does not need to know this—the user only knows that the new agent configuration will tend to increase engagement.

As another example, assume that the agent has been configured with a feature definition that considers only features relating to video games that players have played in the past. Thus, the agent may not consider other characteristics of players when recommending video games, such as other interests that the players may have. On the other hand, it could be true that video game players with shared common interests tend to interact with each other more frequently when playing video games, even if those interactions are not necessarily related to game play. For instance, a group of players of an online basketball game may find that they also share an interest in politics and discuss politics when playing the basketball game.

Now, assume that a user selects a new agent configuration with a very high predicted engagement value. The new agent configuration may have a feature definition that considers other interests of the video game players, e.g., whether the players are members of topic-specific online social media groups (e.g., politics), etc. Because this feature definition enables the agent to consider user context that conveys external interests of the video game players, the new agent configuration increases engagement compared to the previous configuration that did not consider external user interests. Again, the user selecting the new configuration does not necessarily need to be concerned with what features the agent uses in the new configuration, only that the new configuration tends to increase engagement relative to the previous or other alternative agent configurations.

### Further Context Features for Content Distribution

One type of context vector useful for content distribution, such as distribution of video games or streaming media, is a user vector characterizing one or more characteristics of a particular user. There are many different ways to describe or define a user as a set of features or signals. The characteristics of the user may include fixed user features such as, a user identifier (e.g., user gaming identifier), age, gender, location, sexual orientation, race, language, and the like. The characteristics of the user can also include dynamic user features, for example, purchase tendency, genre affinity, publisher affinity, capability affinity, social affinity, purchase history, interest history, wish list history, preferences, social media contacts or groups, and characteristics of the user's social media contexts or groups. There may be a very high number of features or signals in a user vector. The feature generator 202 may generate a user vector that includes one or more user features for each user. Other context features can represent the time of the day, the day of the week, the month of the year, a season, a holiday, etc. In some implementations, the user information can be maintained in a privacy preserving manner.

Each available item of content is a potential action for the agent. In other words, the agent can choose to recommend any specific item of content given a current context of the environment, according to the agent's current policy. Thus, in this case, the action features can be represented as content vectors for each of a plurality of contents (e.g., games, movies, music, etc. The content information may be manually provided or obtained from a database of contents. There are many different ways to describe or characterize content. A content vector can include a plurality of characteristics of a specific content (e.g., a particular game), for example, text about the content, metadata regarding the content, pricing information, toxicity, content rating, age group suitability, genre, publisher, social, the number of users, etc. The feature generator 210 can generate metrics for the various features related to content, such as an inclusiveness metric, a safety metric, a toxicity metric, etc.

Each time the agent chooses an action, e.g., outputs a content item to the user, the environment reacts. For instance, the user can click on a content item, ignore the content item, etc. For example, user reactions can include viewing content, selecting content, clicking on content or any other item on the display screen, purchasing, downloading, spending money, spending credits, commenting, sharing, hovering a pointer over content, playing, socializing, failing to select any of the personalized contents (e.g., within a predefined period of time), minimizing, idling, exiting the platform (e.g., a game store), etc. Any of these user actions can be represented by corresponding reaction features.

Note that some implementations may also consider various context features that characterize the client device being used to consume electronic content. For instance, the agent may be provided with context features identifying a processing unit of the client device, whether the client device has a particular type of hardware acceleration capability (e.g., a graphics processing unit), amount of memory or storage, display resolution, operating system version, etc. In this case, the agent may learn that certain games or other executables cannot run, or run poorly, on devices that lack certain technical characteristics. For instance, referring back to FIG. 10A, the agent may learn that the driving game 1002(1) does not run well on devices with less than a specified amount of RAM, and can instead learn to select sports game 1002(4).

The environmental reaction measured by the agent can be a result of the user intentionally ending the game in a short period of time, or an explicit signal from the client device such as measuring memory or CPU utilization. Thus, for instance, the agent might learn that device type A (e.g., lacking a GPU but having a lot of RAM) exhibits high CPU utilization when executing driving game 1002(1), device type B (e.g., having a GPU but lacking enough RAM) exhibits high memory utilization when executing driving game 1002(1), and device type C exhibits moderate memory and CPU utilization when executing the driving game. Thus, the agent may learn to recommend the sports video game 1002(4) to devices of type A and B, while recommending the driving video game to devices of type C.

### Use Case for Video Call Applications

For the purposes of this example, server application 831 can be an application that provides video call functionality to users of client application 821 on client device 820. Agent 102 can be an agent that receives an API from the application, where the API call identifies multiple different technical configurations to the agent as well as context reflecting the technical environment in which video calls will be conducted. Each technical configuration is a potential action for the agent. The agent can return the highest-ranked configuration to the application.

One example of a potential technical configuration for a video call application is the playout buffer size. A playout buffer is a memory area where VOIP packets are stored, and playback is delayed by the duration of the playout buffer. Generally, the use of playout buffers can improve sound quality by reducing the effects of network jitter. However, because sound play is delayed while filling the buffer, conversations can seem relatively less interactive to the users if the playout buffer is too large.

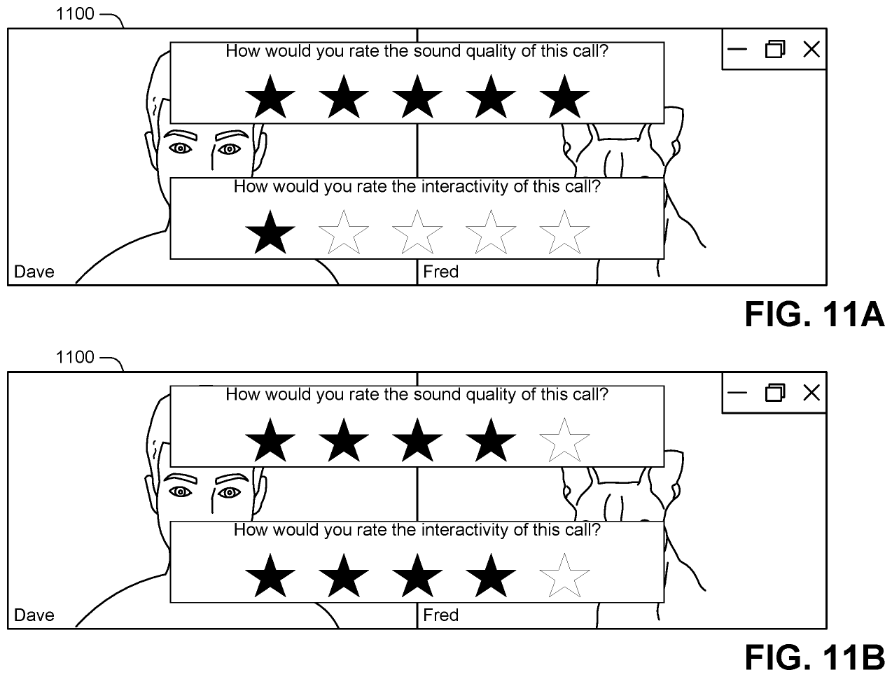

Assume, in a first instance, that the agent has been configured with a reward function that calculates rewards based solely on whether the playout buffer ever becomes empty, e.g., playback needs to be paused while waiting for new packets. Thus, the reward function may tend to prefer large playout buffers that almost never become empty. However, large playout buffers imply a longer delay from packet receipt until the audio/video data is played for the receiving user, which can result in perceptible conversational latency. FIG. 11A illustrates a video call GUI 1100 with high sound quality ratings, but low interactivity ratings, which reflects how a human user (e.g., of client device 820) might perceive call quality using such a configuration.

Now assume that the agent has been reconfigured according to a different reward function that considers both whether the playout buffer becomes empty as well as the duration of the calls. Here, the agent may learn that larger playout buffers tend to empty less frequently, but that calls with very large playout buffers tend to be terminated by users that are frustrated by the relative lack of interactivity. Thus, the agent may tend to learn to choose a moderate-size playout buffer that provides reasonable call quality and interactivity. FIG. 11B illustrates video call GUI 1100 with relatively high ratings for both sound quality and interactivity.

A user who is selecting an agent configuration for this scenario might consider evaluation metrics such as call quality or interactivity, since these are the aspects of the call that are important to end users. Such a user may not have a great deal of technical expertise and might have a difficult time specifying a reward function over reactions such as the playout buffer emptying. Nevertheless, the user can implicitly choose an agent configuration having such a reward function while specifying their evaluation metric in a more intuitive manner, e.g., average user ratings of sound quality and interactivity.

In addition to the learning rate, another hyperparameter that can influence agent is the search strategy. Consider a previous agent configuration with an epsilon-first strategy, where the agent randomly selects playout buffer sizes for a specific number of trials in a first phase and then subsequently enters an exploitation phase where the agent consistently selects the best playout buffer size without further exploration. In practice, such a strategy might frustrate users in the exploration phase, and this could cause users to terminate calls early. By switching to an epsilon-greedy strategy where the best (highest expected reward) playout buffer size is randomly selected 90% of the time (using epsilon equal to 0.1), the agent can still learn to adapt to changing call conditions while more consistently providing a good call experience for users. Again, the user who selects a specific agent configuration does not need to specify that they want to change from the epsilon-first strategy to the epsilon-greedy strategy. Instead, the user simply specifies a configuration that provides an appropriate balance between call quality and interactivity, and implicitly changes the agent hyperparameter without necessarily even being aware that they have done so.

With respect to feature definitions, one feature that an agent might consider is network jitter, e.g., the variation in time over which packets are received. Jitter can be measured over any time interval, e.g., the variation in packet arrival times can be computed over just a few packets or over a longer duration (e.g., an entire call). Consider a previous agent configuration that uses a feature definition for network jitter computed over a large number of packets. If network jitter suddenly changes, it may take such an agent a long time to recognize the change and make corresponding changes to the size of the playout buffer. A new agent configuration that uses a measure of jitter computed over a shorter period of time may result in better sound quality and interactivity. Here again, the user does not need to explicitly configure the agent to use a specific feature definition for jitter. Rather, various feature definitions can be evaluated using the event log to determine how they will impact sound quality and interactivity, and the user can simply pick whichever configuration balances sound quality and interactivity according to their preferences. This implicitly allows the user to specify a feature definition for jitter without manually defining such a feature.

The context features, action features, and reaction features for voice call applications can be different than those used for content personalization. For instance, context features might represent the location and identities of parties on a given call, whether certain parties are muting their microphones or have turned off video, network jitter and delay, whether users are employing high-fidelity audio equipment, whether a given user is sending multicast packets, etc. Action features might describe the size of the playout buffer as well as any other parameters the agent may be able to act on, e.g., VOIP packet size, codec parameters, etc. Reaction features might represent buffer over- or under-runs, quiet periods during calls, call duration, etc. In some cases, automated characterization of sound quality or interactivity can be employed to obtain reaction features, e.g., Rix et al., “Perceptual Evaluation of Speech Quality (PESQ)-A New Method for Speech Quality Assessment of Telephone Networks and Codecs,” 2001 IEEE International Conference on Acoustics, Speech, and Signal Processing. Proceedings, 2001.

### TECHNICAL EFFECT

As noted above, manual configuration of reinforcement learning agents is a difficult task. It may be difficult for a user to manually specify a reward function that adequately represents the desired behavior of the agent. Likewise, it may be difficult for users to specify hyperparameters or feature definitions that result in good performance by an agent that uses reinforcement learning.

The disclosed implementations can predict how different agent configurations will perform for different evaluation metrics. This allows users to evaluate the different agent configurations according to the metrics that interest the user. Thus, the user can balance how different agent configurations are likely to perform with respect to different metrics of interest, without having to specify what reward function, hyperparameters, or features the agent should use. In addition, note that a user can specify how different reactions, actions, and environmental context map to different values of the metrics that interest the user, e.g., by providing one or more functions. These functions do not need to be available at the time that the event logs are constructed. Rather, offline analysis can be performed to determine how, for instance, clicks, comments, and likes can be mapped to a user engagement metric, how different video games played in different countries can be mapped to a revenue metric, or how different instrumented features of a video call can be mapped to a call quality or interactivity metric.

Thus, the disclosed implementations can partially or fully automate the process of configuring an agent to perform reinforcement learning. As a consequence, the agent can be configured to adapt its own internal parameters in response to various environmental reactions. In addition, the disclosed implementations can evaluate alternative agent configurations offline using existing log data that was generated by a previous agent configuration. Thus, the agent does not need to be deployed for real-world applications to analyze each agent configuration. Rather, the relative performance of alternative agent configurations can be predicted on existing log data, thus mitigating the risk of deploying an agent that performs poorly with respect to one or more evaluation metrics.

### Device Implementations

As noted above with respect to FIG. 8, system 800 includes several devices, including a client device 810, a client device 820, a server 830, and a server 840. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 850. Without limitation, network(s) 850 can include one or more local area networks (LANs), wide area networks (WANs), the Internet, and the like.

Various examples are described above. Additional examples are described below. One example includes a method comprising obtaining an event log of events representing reactions of an environment to actions taken by an agent, the agent having selected the actions according to a previous agent configuration based at least on context associated with the events, based at least on the events in the event log, predicting performance of a plurality of alternative agent configurations for an evaluation metric, wherein the plurality of alternative agent configurations including at least two different reward functions, based at least on the predicted performance of the plurality of alternative agent configurations for the evaluation metric, identifying a selected agent configuration having a corresponding selected reward function, and configuring the agent according to the selected agent configuration, the selected agent configuration causing the agent to adapt internal parameters of the agent according to the selected reward function.

Another example can include any of the above and/or below examples where the plurality of alternative agent configurations include a plurality of alternative agent hyperparameters, and the selected agent configuration includes a selected hyperparameter.

Another example can include any of the above and/or below examples where the plurality of alternative agent configurations include a plurality of alternative feature definitions, and the selected agent configuration includes a selected feature definition.

Another example can include any of the above and/or below examples where predicting the performance of the plurality of alternative agent configurations comprises determining, from the event log, predicted aggregate values of the evaluation metric for the plurality of alternative agent configurations.

Another example can include any of the above and/or below examples where determining the predicted aggregate values of the evaluation metric comprises, for each particular event in the event log determining a value of the particular event for the evaluation metric, the value being determined based on a particular reaction of the environment to a particular action taken in a particular context by the agent in the previous agent configuration and weighting the value of the particular event to obtain weighted values of the evaluation metric for the plurality of alternative agent configurations, the weighting being based on corresponding probabilities that plurality of alternative agent configurations give to the particular action relative to a probability that the previous agent configuration gave to the particular action and aggregating the weighted values of each particular event for each alternative agent configuration to obtain the predicted aggregate values of the evaluation metric.

Another example can include any of the above and/or below examples where the method further comprises determining the value of the particular event based on a function for the evaluation metric.

Another example can include any of the above and/or below examples where the function maps the actions and the context to the values of the evaluation metric.

Another example can include any of the above and/or below examples where the method further comprises populating a data structure with predicted aggregate values of a plurality of evaluation metrics for the plurality of alternative agent configurations.

Another example can include any of the above and/or below examples where the data structure comprises a table with rows representing different agent configurations and columns representing different evaluation metrics.

Another example can include a system comprising a processor and a storage medium storing instructions which, when executed by the processor, cause the system to identify a selected agent configuration having a corresponding selected reward function based at least on predicted performance of a plurality of alternative agent configurations for an evaluation metric and operate the agent in the selected agent configuration, the selected agent configuration causing the agent to adapt internal parameters of the agent according to the selected reward function.

Another example can include any of the above and/or below examples where the instructions which, when executed by the processor, cause the system to adapt the internal parameters of the agent by using the selected reward function to evaluate reactions of an environment to actions taken by the agent based on context describing the environment.

Another example can include any of the above and/or below examples where the agent comprises a linear model that determines a probability density function of expected rewards for different actions based on the selected reward function.

Another example can include any of the above and/or below examples where the agent randomly samples from the probability density function and, in at least some instances, chooses an action that does not have the highest expected reward.

Another example can include any of the above and/or below examples where there agent comprises a contextual bandit.

Another example can include any of the above and/or below examples where the actions comprise recommending electronic items, the reactions indicate whether users selected the recommended electronic items, and the context comprises information about the users.

Another example can include any of the above and/or below examples where the actions comprise determining playout buffer sizes for video calls.

Another example can include any of the above and/or below examples where the reactions indicate whether a playout buffer became empty during the video calls and the context indicates network jitter during the video calls.

Another example can include a computer-readable storage medium storing instructions which, when executed by a computing device, cause the computing device to perform acts comprising based at least on predicted performance of a plurality of alternative agent configurations for an evaluation metric, identifying a selected agent configuration having a corresponding selected reward function, configuring the agent according to the selected agent configuration having the selected reward function, receiving, from an application, an application programming interface (API) call to the agent requesting that the agent select an action from a plurality of available actions based on a current context of an environment, selecting a particular action from the plurality of available actions based at least on reward values determined according to the selected reward function, and responding to the API call by identifying the particular action to the application.

Another example can include any of the above and/or below examples where the acts further comprise receiving, from the application, a reaction of the environment to the particular action, determining a reward value for the particular action based at least on the reaction and the selected reward function, and updating internal parameters of the agent based at least on the reward value.

Another example includes a method comprising obtaining an event log of events representing reactions of an environment to actions taken by an agent, the agent having selected the actions according to a previous agent configuration based at least on context associated with the events, based at least on the events in the event log, predicting performance of a plurality of alternative agent configurations for an evaluation metric, wherein the plurality of alternative agent configurations including at least two different reward functions, based at least on the predicted performance of the plurality of alternative agent configurations for the evaluation metric, identifying a selected agent configuration having a corresponding selected reward function, and configuring the agent according to the selected agent configuration, the selected agent configuration causing the agent to adapt internal parameters of the agent according to the selected reward function.

Another example can include any of the above and/or below examples where the identifying the selected agent configuration is performed automatically in the absence of human input.

Another example can include any of the above and/or below examples where the identifying the selected agent configuration is performed automatically by selecting from a Pareto front of the plurality of alternative agent configurations.

Another example can include any of the above and/or below examples where the method further comprises operating the agent in the selected agent configuration and adapting the internal parameters of the agent by using the selected reward function to evaluate further reactions of the environment to further actions taken by the agent after being configured in the selected agent configuration.

Another example can include any of the above and/or below examples where operating the agent comprises receiving an application programming interface call from an application and selecting a technical configuration for the application in response to the application programming interface call.

Another example can include any of the above and/or below examples where the application is a voice or video call application and the technical configuration indicates a buffer size of a playout buffer for the application.

Another example can include any of the above and/or below examples where wherein the selected reward function considers both whether the playout buffer becomes empty and respective durations of voice or video calls.

Another example can include any of the above and/or below examples where the plurality of alternative agent configurations include a plurality of alternative agent hyperparameters, and the selected agent configuration includes a selected hyperparameter.

Another example can include any of the above and/or below examples where the plurality of alternative agent configurations include a plurality of alternative feature definitions, and the selected agent configuration includes a selected feature definition.

Another example can include any of the above and/or below examples where predicting the performance of the plurality of alternative agent configurations comprises determining, from the event log, predicted aggregate values of the evaluation metric for the plurality of alternative agent configurations.

Another example can include any of the above and/or below examples where determining the predicted aggregate values of the evaluation metric comprises, for each particular event in the event log: determining a value of the particular event for the evaluation metric, the value being determined based on a particular reaction of the environment to a particular action taken in a particular context by the agent in the previous agent configuration, weighting the value of the particular event to obtain weighted values of the evaluation metric for the plurality of alternative agent configurations, the weighting being based on corresponding probabilities that plurality of alternative agent configurations give to the particular action relative to a probability that the previous agent configuration gave to the particular action, and aggregating the weighted values of each particular event for each alternative agent configuration to obtain the predicted aggregate values of the evaluation metric.

Another example can include any of the above and/or below examples where the method further comprises determining the value of the particular event based on a function for the evaluation metric.

Another example can include any of the above and/or below examples where the function maps the actions and the context to the values of the evaluation metric.

Another example can include any of the above and/or below examples where the method further comprises populating a data structure with predicted aggregate values of a plurality of evaluation metrics for the plurality of alternative agent configurations, outputting a graphical representation of the data structure, and identifying the selected agent configuration based at least on user input directed to the graphical representation of the data structure.

Another example can include a system comprising a processor and a storage medium storing instructions which, when executed by the processor, cause the system to obtain an event log of events representing reactions of an environment to actions taken by an agent, the agent having selected the actions according to a previous agent configuration based at least on context associated with the events, based at least on the events in the event log, predict performance of a plurality of alternative agent configurations for an evaluation metric, wherein the plurality of alternative agent configurations including at least two different reward functions, based at least on the predicted performance of the plurality of alternative agent configurations for the evaluation metric, identify a selected agent configuration having a corresponding selected reward function, and configure the agent according to the selected agent configuration, the selected agent configuration causing the agent to adapt internal parameters of the agent according to the selected reward function.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
obtaining an event log of events representing reactions of an environment to actions taken by an agent, the agent having selected the actions according to a previous agent configuration based at least on context associated with the events;
based at least on the events in the event log, predicting performance of a plurality of alternative agent configurations for an evaluation metric, wherein the plurality of alternative agent configurations including at least two different reward functions;
based at least on the predicted performance of the plurality of alternative agent configurations for the evaluation metric, identifying a selected agent configuration having a corresponding selected reward function; and
configuring the agent according to the selected agent configuration, the selected agent configuration causing the agent to adapt internal parameters of the agent according to the selected reward function.

2. The method of claim 1, wherein the plurality of alternative agent configurations include a plurality of alternative agent hyperparameters, and the selected agent configuration includes a selected hyperparameter.

3. The method of claim 1, wherein the plurality of alternative agent configurations include a plurality of alternative feature definitions, and the selected agent configuration includes a selected feature definition.

4. The method of claim 1, wherein predicting the performance of the plurality of alternative agent configurations comprises:
determining, from the event log, predicted aggregate values of the evaluation metric for the plurality of alternative agent configurations.

5. The method of claim 4, wherein determining the predicted aggregate values of the evaluation metric comprises:
for each particular event in the event log:
determining a value of the particular event for the evaluation metric, the value being determined based on a particular reaction of the environment to a particular action taken in a particular context by the agent in the previous agent configuration; and
weighting the value of the particular event to obtain weighted values of the evaluation metric for the plurality of alternative agent configurations, the weighting being based on corresponding probabilities that plurality of alternative agent configurations give to the particular action relative to a probability that the previous agent configuration gave to the particular action; and
aggregating the weighted values of each particular event for each alternative agent configuration to obtain the predicted aggregate values of the evaluation metric.

6. The method of claim 4, further comprising:
determining the value of the particular event based on a function for the evaluation metric.

7. The method of claim 6, wherein the function maps the actions and the context to the values of the evaluation metric.

8. The method of claim 4, further comprising:
populating a data structure with predicted aggregate values of a plurality of evaluation metrics for the plurality of alternative agent configurations.

9. The method of claim 8, wherein the data structure comprises a table with rows representing different agent configurations and columns representing different evaluation metrics.

10. The method of claim 8, further comprising:
outputting a graphical representation of the data structure; and
identifying the selected agent configuration based at least on user input directed to the graphical representation of the data structure.

11. A system comprising:
a processor; and
a storage medium storing instructions which, when executed by the processor, cause the system to:
identify a selected agent configuration having a corresponding selected reward function based at least on predicted performance of a plurality of alternative agent configurations for an evaluation metric; and
operate the agent in the selected agent configuration, the selected agent configuration causing the agent to adapt internal parameters of the agent according to the selected reward function.

12. The system of claim 11, wherein the instructions which, when executed by the processor, cause the system to:
adapt the internal parameters of the agent by using the selected reward function to evaluate reactions of an environment to actions taken by the agent based on context describing the environment.

13. The system of claim 12, wherein the agent comprises a linear model that determines a probability density function of expected rewards for different actions based on the selected reward function.

14. The system of claim 13, wherein the agent randomly samples from the probability density function and, in at least some instances, chooses an action that does not have the highest expected reward.

15. The system of claim 14, the agent comprising a contextual bandit.

16. The system of claim 12, wherein the actions comprise recommending electronic items, the reactions indicate whether users selected the recommended electronic items, and the context comprises information about the users.

17. The system of claim 12, wherein the actions comprise determining playout buffer sizes for video calls.

18. The system of claim 17, wherein the reactions indicate whether a playout buffer became empty during the video calls and the context indicates network jitter during the video calls.

19. A computer-readable storage medium storing instructions which, when executed by a computing device, cause the computing device to perform acts comprising:
based at least on predicted performance of a plurality of alternative agent configurations for an evaluation metric, identifying a selected agent configuration having a corresponding selected reward function;
configuring the agent according to the selected agent configuration having the selected reward function;
receiving, from an application, an application programming interface (API) call to the agent requesting that the agent select an action from a plurality of available actions based on a current context of an environment;
selecting a particular action from the plurality of available actions based at least on reward values determined according to the selected reward function; and
responding to the API call by identifying the particular action to the application.

20. The computer-readable storage medium of claim 19, the acts further comprising:
receiving, from the application, a reaction of the environment to the particular action;
determining a reward value for the particular action based at least on the reaction and the selected reward function; and
updating internal parameters of the agent based at least on the reward value.
